(19) United States
(12) Patent Application Publication
(10) Pub. No.: US 2025/0086405 A1
(43) Pub. Date: Mar. 13, 2025

(54) PROMPT COMPLEXITY FOR LARGE LANGUAGE MODELS

(71) Applicant: GOOGLE LLC, Mountain View, CA (US)

(72) Inventors: Swaroop Mishra, Mountain View, CA (US); Ragha Kotikalapudi, San Jose, CA (US); Obaid Sarvana, Chicago, IL (US); Sahitya Potluri, Sunnyvale, CA (US); YaGuang Li, Sunnyvale, CA (US); Taylor Bos, Santa Clara, CA (US); Steven Zheng, San Bruno, CA (US); Hanzhao Lin, Cupertino, CA (US); Chenkai Kuang, Sunnyvale, CA (US); Heng-Tze Cheng, Mountain View, CA (US); Ed H. Chi, Los Altos, CA (US); Quoc Le, Sunnyvale, CA (US)

(21) Appl. No.: 18/481,803

(22) Filed: Oct. 5, 2023

Related U.S. Application Data
(60) Provisional application No. 63/537,095, filed on Sep. 7, 2023.

(51) Int. Cl. G06F 40/40; G06N 3/08

(52) U.S. Cl. CPC G06F 40/40; G06N 3/08

(57) ABSTRACT

Some implementations relate to generating a training and/or evaluation dataset with LLM prompts (e.g., derived from user queries) based on a prompt complexity. An input prompt, for example derived from a user query, is received. The input prompt is decomposed into a prompt tree comprising a plurality of nodes. The plurality of nodes comprise: a plurality of leaf nodes corresponding to simple sub-prompts of the input query; a plurality of branch nodes of sub-prompts each corresponding to multiple simple sub-prompts; and a root node corresponding to the input prompt. A prompt complexity is determined based on a path length of the prompt tree. The prompt complexity is compared to a threshold complexity. If the prompt complexity is above the threshold complexity, the input prompt is included in a set of training prompts and/or a set of evaluation prompts.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects NL content and/or other content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilizations of generative models suffer from one or more drawbacks.

As one example, LLMs can be utilized as part of a text-based dialog application, generating responses to textual inputs/queries provided by a user of the application. However, complex input prompts, for example prompts that refer to several entities or contain multiple subtasks, can be difficult for the LLM to handle effectively.

### SUMMARY

Some implementations disclosed herein are directed to at least augmenting a training and/or evaluation dataset with LLM prompts (e.g., derived from user queries) based on a prompt complexity. An input prompt, for example derived from a user query, is received. The input prompt is decomposed into a prompt tree comprising a plurality of nodes. The plurality of nodes comprise: a plurality of leaf nodes corresponding to simple sub-prompts of the input query; a plurality of branch nodes of sub-prompts each corresponding to multiple simple sub-prompts; and a root node corresponding to the input prompt. A prompt complexity is determined based on a path length of the prompt tree. The prompt complexity is compared to a threshold complexity. If the prompt complexity is above the threshold complexity, the input prompt is included in a set of training prompts and/or a set of evaluation prompts.

In these, and other, manners, the complexity of prompts for an LLM can be quantified. The quantification can be utilized to identify hard prompts for inclusion in a set of training prompts and/or evaluation prompts. Such training sets can be used to train LLMs (e.g., fine tune an existing LLM or train a new LLM) that have improved performance on complex prompts. Furthermore, the prompt complexity can be utilized to: (1) form hierarchies in the evaluation dataset to better understand the strength and weakness of an LLM; (2) control a degree of prompt hardness while filtering prompts from logs to continuously update the evaluation/training dataset; and/or (3) balance an instruction-tuning mixture, and control the distribution of prompt complexity to match with a user prompt distribution as evident from logs. Notably, utilization of the length of the prompt tree in determining the prompt complexity can, for various prompt pairs, result in determining a prompt complexity, for a shorter text-length of the prompts, that indicates greater complexity than does a determined prompt complexity for a longer text-length text of the prompts. Put another way, utilization of the length of the prompt tree of a prompt in determining prompt complexity, as opposed to only utilization of a text-length of the prompt, results in more accurate quantification of the complexity of the prompt.

Some implementations disclosed herein are additionally or alternatively directed to at least invoking, by an LLM, one or more external applications based on a decomposition of an input prompt into a plurality of sub-prompts. An input prompt for an LLM is received from a client device. The input prompt is decomposed into a plurality of simple sub-prompts. For at least one sub-prompt in the plurality of simple sub-prompts, a determination is made to invoke an external application from a plurality of external applications accessible by the LLM. The determination is based on the at least one simple sub-prompt relating to subject matter within a domain of the external application. The external application is invoked using the one or more simple sub-prompts. Responsive to invoking the external application using the one or more simple sub-prompts, one or more responses are received from the external application. Based at least in part on the one or more responses from the external application, the LLM generates a response to the input prompt. The generated response to the input prompt is rendered at the client device.

In these, and other, manners, multiple external applications can be invoked, each to deal with a respective part of a complex input prompt. This can allow an LLM to respond to a complex input prompt.

In some implementations, an LLM can include at least hundreds of millions of parameters. In some of those implementations, the LLM includes at least billions of parameters, such as one hundred billion or more parameters. In some additional or alternative implementations, an LLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialog Applications (LaMDA). However, and as noted, it should be noted that the LLMs described herein are one example of generative machine learning models are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method of updating a set of training and/or evaluation prompts for an LLM based on a complexity measure.

FIG. 3 depicts an overview of an example method for responding to an input prompt to an LLM using one or more external applications.

FIG. 4 depicts an example of a prompt decomposition tree.

FIG. 5 depicts a flowchart that illustrates an example method for determining whether to include an input prompt in a set of training/evaluation prompts.

FIG. 6 depicts a flowchart that illustrates an example method of using one or more external applications to respond to a complex query.

FIG. 7 depicts an example architecture of a computing device, in accordance with various implementations.

### DETAILED DESCRIPTION

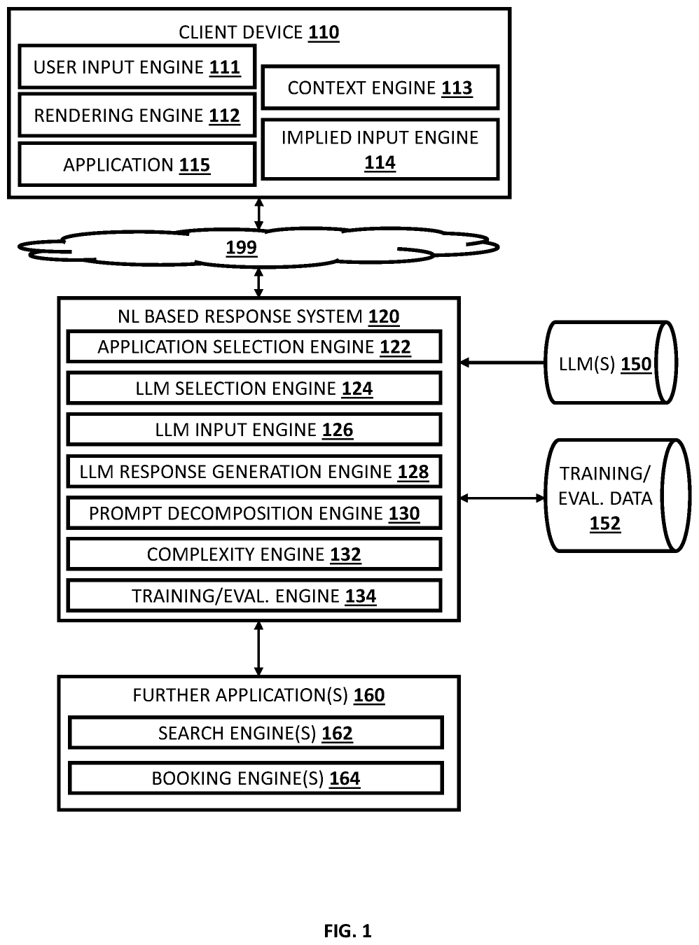

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and one or more further applications 160 (i.e. applications external to an LLM or a dialog application executed on the client device 110). Although illustrated separately, in some implementations all or aspects of NL based response system 120 and all or aspects of the one or more further applications 160 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based summary result automatically rendered. It is noted that the provided NL based summary result can vary over time in view of e.g., presence of new/fresh search result document(s) over time.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including an application selection engine 122, an LLM selection engine 124, an LLM input engine 126, an LLM response generation engine 128, a prompt decomposition engine 130, a prompt complexity engine 132, and a training engine 134. Some of the engines can be omitted in various implementations. In some implementations, the engines of the NL-based response system are distributed across one or more computing systems.

The application selection engine 122 can, in response to receiving a query, determine one or more external applications 160 to invoke. The application selection engine 122 can select applications that are relevant to the query, e.g., determine that the input query is directed towards subject matter within the domain of one or more external applications, and select/invoke one or more of the external applications in response.

The LLM selection engine 124 can, in response to receiving a query, determine which, if any, of multiple generative model(s) (LLM(s) 150 and/or other generative model(s)) to utilize in generating response(s) to render responsive to the query. For example, the LLM selection engine 124 can select none, one, or multiple generative model(s) to utilize in generating response(s) to render responsive to a query. The LLM selection engine 124 can optionally utilize one or more classifiers and/or rules (not illustrated).

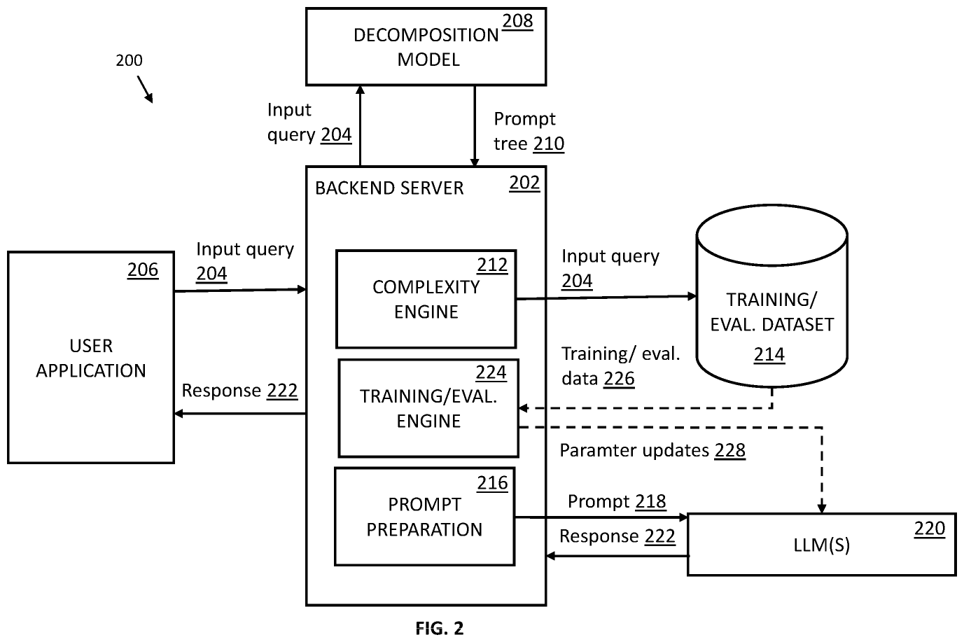

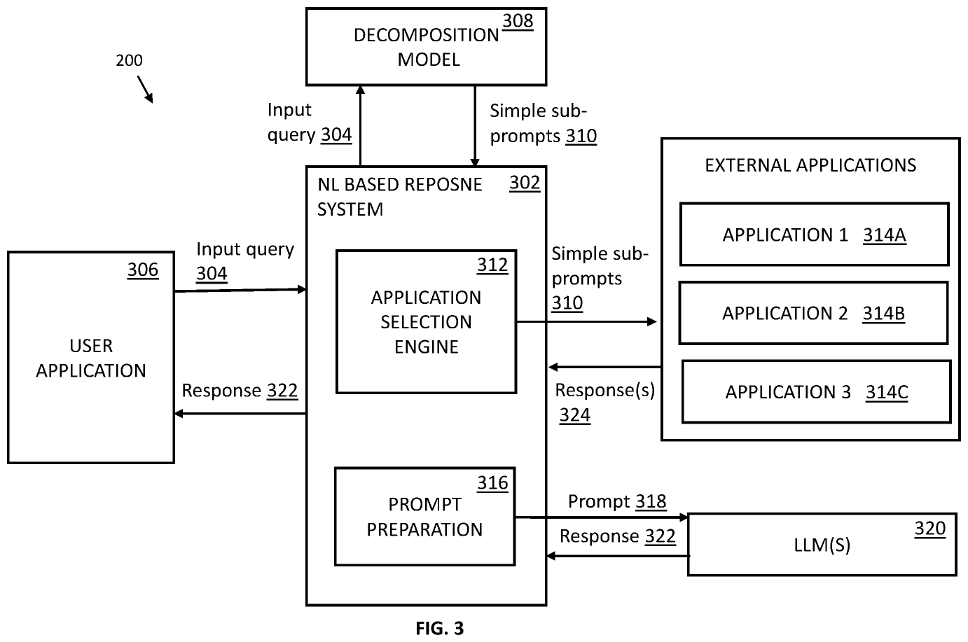

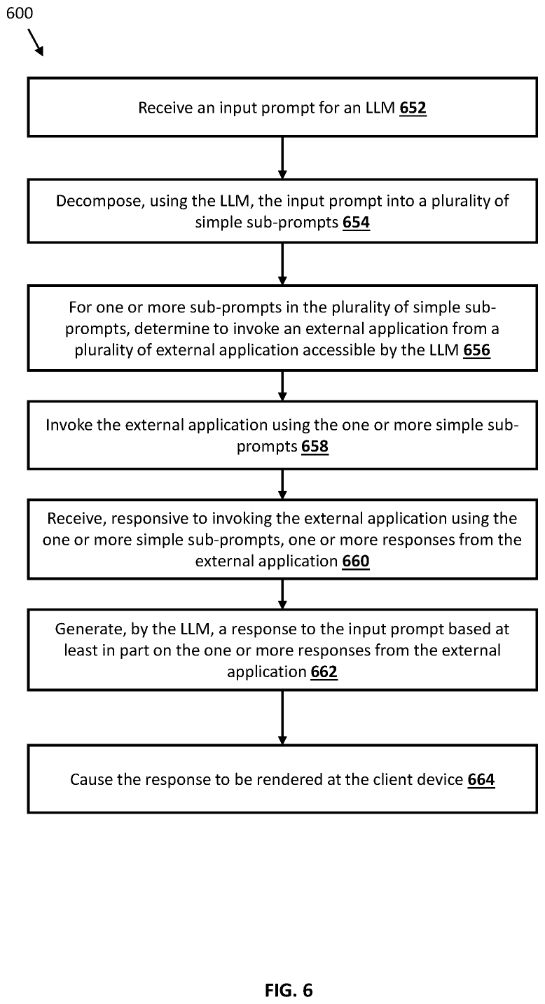

The LLM input engine 126 can, in response to receiving a query, generate LLM input that is to be processed using an LLM in generating an NL based response to the query. As described herein, such content can include query content that is based on the query and/or additional content, such as contextual information derived from the one or more further applications 160. In various implementations, the LLM input engine 126 can perform all or aspects of the prompt preparation engine 216, 316 of FIG. 2 and FIG. 3, and/or aspects of blocks 662 of method 600 of FIG. 6.

The LLM response generation engine 128 can process LLM input, that is generated by the LLM input engine 126, using an LLM to generate an NL based response. In various implementations, the LLM response generation engine 128 can perform all or aspects of the LLM(s) 220, 320 of FIG. 2 and FIG. 3 and/or block 662 of method 600 of FIG. 6. The LLM response generation engine 128 can utilize one or more LLMs 150.

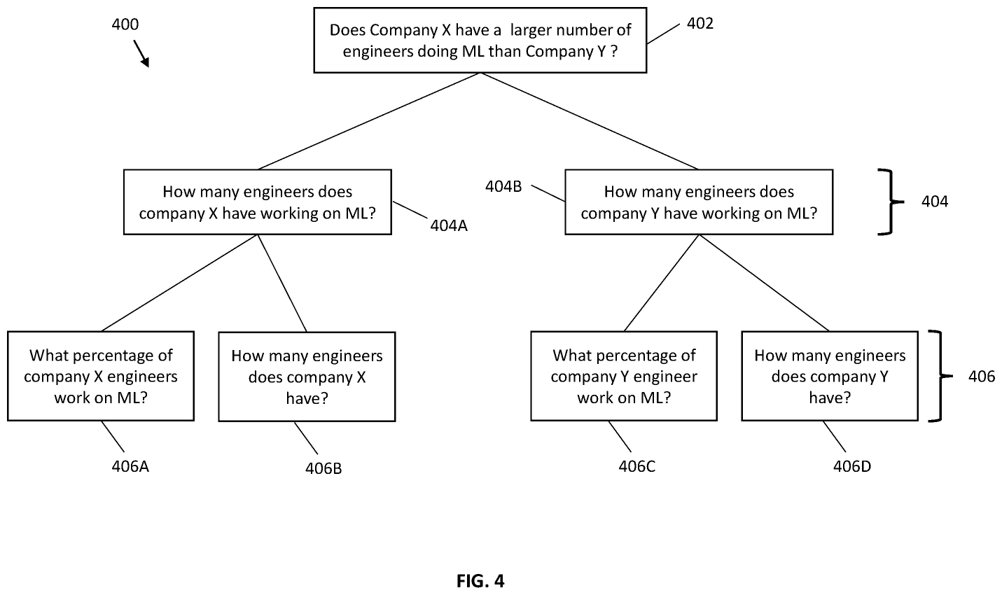

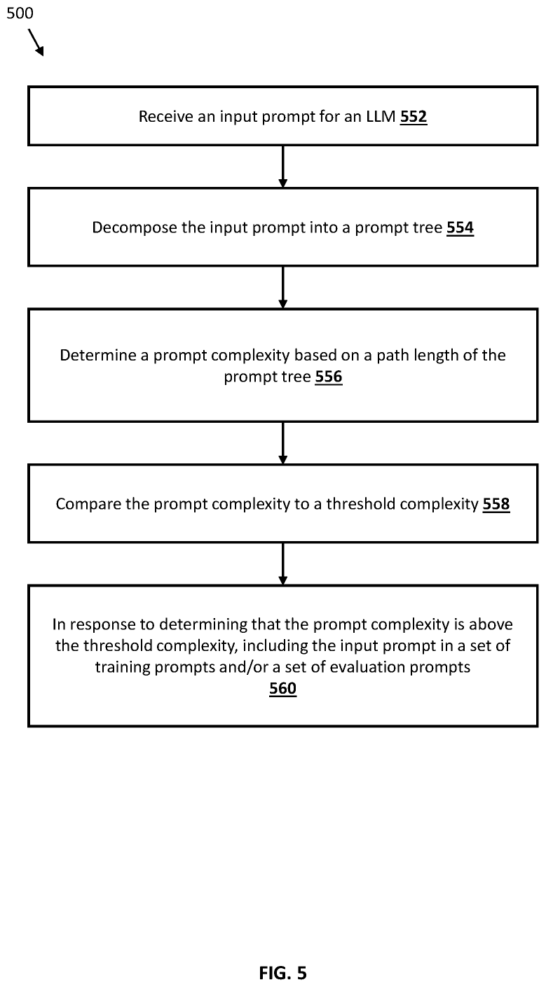

The prompt decomposition engine 130 can process an input prompt/query to decompose the input prompt into a plurality of sub-prompts. The prompt decomposition engine 130 can utilize one or more LLMs 150 to break down the input query/prompt into the plurality of sub-prompts. In some implementations, the prompt decomposition engine 130 can decompose the input prompt into a prompt decomposition tree (also referred to herein as a prompt tree), for example as shown in FIG. 4. In various implementations, the prompt decomposition engine 130 can perform all or aspects of block 554 of method 500 of FIG. 5 and/or block 654 of method 600 of FIG. 6.

The complexity engine 132 can determine a complexity measure for an input prompt/query and/or a sub-prompt. The complexity measure is, in some implementations, based on path length of the prompt decomposition tree determined by the prompt decomposition engine 130. Based on the determined complexity, e.g., if the complexity is above a threshold value, the complexity engine 132 can determine to store an input prompt as an example of a “hard prompt” in a training/evaluation dataset 152. In various implementations, the complexity engine 132 can perform all or aspects of block 556 of FIG. 5.

The training/evaluation engine 134 can train and/or evaluate the one or more LLMs 150. For example, the training/evaluation engine 134 can use training data from a training dataset to retrain/fine-tune parameters of one or more of the LLMs 150. Alternatively or additionally, the training/evaluation engine 134 can use evaluation data from an evaluation dataset to evaluate the performance of one or more of the LLMs 150.

The set of external applications 160 is illustrated as including one or more search engines 162 and one or more booking engines 164. Some of the engines can be omitted in various implementations. Further external applications may also be included in the set of external applications 160.

The one or more search engines 162 can receive a search request from the NL-based response system 120 and perform a search operation on a search space. The search engine can return one or more search results to the NL-based response system 120. The one or more search results may, for example, be used by the LLM input engine to generate an intermediate input prompt for the LLM. The one or more search engines may comprise an internet search engine.

The one or more booking engines 164 can receive a request for information for a service, e.g., a hotel, flight tickets, train tickets, event tickets etc., and return the requested information relating to the service. Such information may, for example, comprise service availability, service prices or the like.

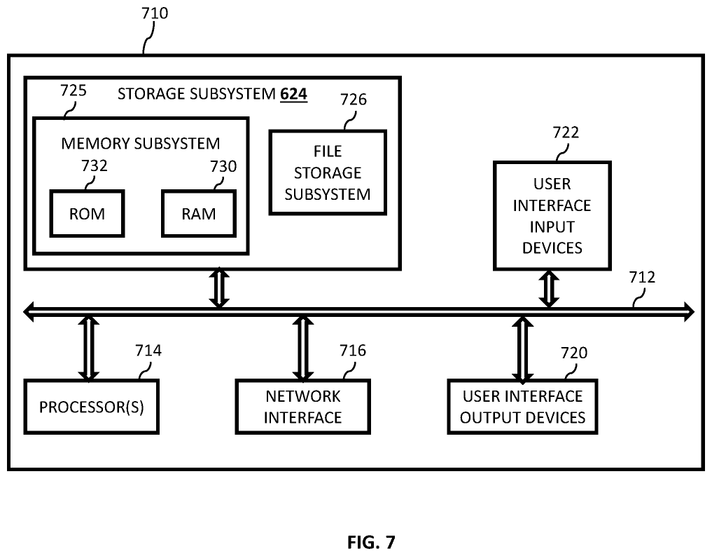

Turning now to FIG. 2, FIG. 2 illustrates an overview of an example method for updating a set of training and/or evaluation prompts for an LLM based on a complexity measure. The method may be performed by one or more computing systems, such as the system described herein with respect to FIG. 7.

A computer system, such as backend server 202 (e.g., the NL based response system 120 described herein in relation to FIG. 1), receives an input query 204 (also referred to herein as an input prompt). The input query 204 comprises natural language input that explicitly and/or implicitly raises a query. The input prompt 204 is processed by a decomposition model 208, which decomposes the input query into a prompt tree 210 that comprises a plurality of simple sub-prompts. The prompt tree is input into a complexity engine 212, which processes the prompt tree to determine a measure of complexity of the input prompt 204. The complexity engine 212 compares the prompt complexity to a threshold complexity. If the threshold complexity is exceeded, the input prompt 204 is stored as part of a training and/or evaluation dataset 214. The input prompt 204 and/or the plurality of simple sub-prompts are used by a prompt preparation engine 216 to prepare a prompt 218 for one or more LLMs 220. The one or more LLMs 220 process the prompt 218 to generate one or more responses 222 to the input query 204. One or more of the responses 222 are output to a user via the user application 206 on the client device. Subsequently, a training/evaluation engine 224 uses training/evaluation data 226 stored in the training and/or evaluation dataset 214 to train and/or evaluate the performance of the one or more LLMs 220 and/or one or more other LLMs (not shown). If training is performed, updated parameter values 228 are used to update the LLMs 220 and/or the one or more other LLMs.

The input query 204 is, in some examples, received in the form of an input text query. The input query 204 can, for example, originate as text input manually by a user of the user application 206. Alternatively or additionally, the input query 204 can originate from a spoken input to the user application 206, e.g. a spoken query input after invoking the user application 206. The spoken input is converted to the input query by a speech-to-text engine running on the client device (either as part of the user application 206, or accessible by the user application 206). The input text query 204 is, in some examples, part of an ongoing human-computer dialog, e.g., a sequence of input queries and their corresponding responses from the NL based response system.

As an example, the input query may be “Does company X have a larger number of engineers doing ML than company Y?”

The decomposition model 208 is configured to receive the input query 208 and break the query down into a prompt tree 210. The prompt tree comprises a root node that corresponds to the input query 204 and a plurality of leaf nodes that correspond to simple sub-prompts that make up the input query. In examples where the input query is not broken down directly into simple sub-prompts, the prompt tree further comprises one or more branch nodes corresponding to intermediate sub-prompts between the input query 204 and the simple sub-prompts, i.e., the intermediate sub-prompts are each composed of a plurality of simple sub-prompts.

In some implementations, the decomposition model 208 iteratively decomposes the input prompt into the simple sub-prompts. At each iteration, the decomposition model determines whether current sub-prompts (e.g., sub-prompts generated at the previous iteration) are simple enough, e.g., have at least a target simplicity. If any of the current sub-prompts are identified as not reaching the target simplicity, the decomposition model 208 decomposes the identified sub-prompts into a plurality of simpler sub-prompts. This process is iterated until the sub-prompts reach the target simplicity.

A target simplicity may be defined in a number of ways. In some implementations, the target simplicity is reached when the decomposition model 208 determines that a sub-prompt cannot be broken down into simpler sub-prompts. Alternatively or additionally, the target simplicity is reached when a sub-prompt is determined to fall within the domain of one or more external applications (e.g., expert models), in other words, when the sub-prompt can be addressed by one or more of the external applications. Alternatively or additionally, the decomposition model 208 may comprise a classifier that can classify input text as being simple or not.

The decomposition model 208 is, in some examples, an LLM, such as an LLM from the one or more LLMs 220. The decomposition model 208 may be provided with a natural language instruction to break the input down into a prompt tree and, in some examples, a format for outputting the prompt tree.

As an example, the input to the decomposition model may be:

“Given a ‘query’, your task is to break it down into simpler sub problems needed to provide a helpful answer.

```
  Output should use the json format and be a valid json object:
  Output:
  {{
  ″query″: ″The query that needs to be broken down into simpler sub problems″,
  ″is_simple″: Output ′true′ if the query is simple enough to answer and does not
require further breakdown. Otherwise output ′false′.
  ″sub_problems: Output empty list if ″is_simple″ above is true. Otherwise output a list
with keys: ″query″, ″is_simple″, ″sub_problems″.
  }}
  --
  Query: {query}
  Output:
  ‘‘‘json
  {{
  ″query″: {query},
  ″is_simple″:
```

Where {query} corresponds to the input query 204, e.g., {Does company X have a larger number of engineers doing ML than company Y?}.

The decomposition model 208 processes the input to generate a prompt tree 210, and outputs data representing the prompt tree 210. In some examples, the decomposition model 208 processes the input query tree multiple times to generate a plurality of decompositions of the input query into respective prompt trees.

An example of data representing a prompt tree for the query “Does company X have a larger number of engineers doing ML than company Y?” using the example input prompt described above is:

```
  {
  “query”: “Does company X have a larger number of engineers doing ML than
company Y?”,
  “is_simple”: false,
  “sub_problems”: [
    {
    “query”: “How many engineers does company X have doing ML?”,
    “is_simple”: false,
    “sub_problems”: [
      {
      “query”: “How many engineers does company X have?”,
      “is_simple”: true,
      “sub_problems”: [ ]
      },
      {
      “query”: “What percentage of company X engineers work on ML?”,
      “is_simple”: true,
      “sub_problems”: [ ]
      }
    ]
    }
    {
    “query”: “How many engineers does company Y have doing ML?”,
    “is_simple”: false,
    “sub_problems”: [
      {
      “query”: “How many engineers does company Y have?”,
      “is_simple”: true,
      “sub_problems”: [ ]
      },
      {
      “query”: “What percentage of company Y engineers work on ML?”,
      “is_simple”: true,
      “sub_problems”: [ ]
      }
    ]
    }
  ]
  }
```

The complexity engine 212 takes the prompt tree 210 output by the decomposition model 208 and determines a complexity value for the input prompt based on the depth of the prompt tree 210. For example, the complexity engine determines a total path length of the prompt tree 210 by summing the lengths of each path from a leaf node to the root node of the prompt tree 210. The complexity may be based on a logarithm of the total path length, e.g., the logarithm to the base two of the total path length. Examples of complexity determinations are described herein in further detail with respect to FIG. 4.

In examples where the decomposition model 208 determines multiple breakdowns of the input prompt 204, i.e., multiple prompt trees 210, the complexity engine 212 determines a respective complexity value for each prompt tree 210, and averages the respective complexity values to obtain an overall complexity.

The complexity engine 212 compares the determined complexity for the input prompt 204 to a threshold complexity value. If the threshold value is exceeded, the complexity engine stores the input prompt 204 in a training and/or evaluation dataset 214 as an example of a hard prompt.

The threshold complexity value may be a fixed value. Alternatively or additionally, the threshold complexity value may be a dynamic value that changes based on the performance of the one or more LLMs 220. For example, if the one or more LLMs 220 show a high performance on an evaluation dataset, then the threshold complexity can be increased. If the one or more LLMs 220 show a low performance on an evaluation dataset, then the threshold complexity can be reduced.

The complexity value of the prompt is, in some examples, also stored, regardless of the threshold value being exceeded or not. This can provide statistics of the distribution of complexity values for input prompts, allowing the training and/or evaluation dataset 214 to be adapted to reflect the real-world distribution of input prompts.

The input prompt 204 and, in some examples, the prompt tree 210 are provided to the prompt preparation engine 216, which uses them to prepare an LLM prompt 218. The LLM prompt 218 may, for example, comprise the input query 204 and the simple sub-prompts determined by the decomposition engine 208. For example, the input prompt can be in the form “Respond to the following query politely: [input query]. Here is a breakdown of this query: [simple sub-prompts]”. Alternatively, the LLM prompt 218 may, for example, comprise the input query 204 and the full prompt tree 210 determined by the decomposition engine 208. For example, the input prompt can be in the form “Respond to the following query politely: [input query]. Here is a prompt tree of the query: [prompt tree]”.

The one or more LLMs 220 process the LLM prompt 218 to generate a natural language response 222 to the input query 204. The response 222 is then rendered at the user application 206, e.g., as text in a text-based dialog/chat application, converted to speech using a text-to-speech engine or the like.

Subsequently, the training dataset 214 can be used to train one or more of the LLMs and/or one or more further LLMs. In some examples, the training dataset 214 can be used to finetune an existing LLM, e.g., one of the LLMs 220. Alternatively or additionally, the training dataset 214 can be used to train a new LLM from scratch. Training data 226 from the training dataset 214 can be used by a training engine 224 to determine a set of parameter updates 228 for parameters of one or more of the LLMs 220 or a further LLM.

Alternatively or additionally, the evaluation dataset 214 can be used to evaluate the performance of the one or more LLMs 220, or a further LLM. An evaluation engine 224 processes evaluation data 226 from the evaluation dataset 214 using the LLM under evaluation to generate respective outputs for prompts in the evaluation dataset. Based on the outputs, the performance of the LLM can be evaluated, e.g., by comparing the outputs to ground truth outputs provided by a human annotator.

Turning now to FIG. 3, FIG. 3 illustrates an overview of an example method for responding to an input prompt to an LLM using one or more external applications. The method may be performed by one or more computing systems, such as the system described herein with respect to FIG. 7. The operations of FIG. 3 are, in some examples, performed in addition to the operations of FIG. 2.

A computer system, such as an NL-based response system 302 (e.g., the NL based response system 120 described herein in relation to FIG. 1), receives an input query 304 (also referred to herein as an input prompt). The input query 304 comprises natural language input that explicitly and/or implicitly raises a query. The input prompt 304 is processed by a decomposition model 208, which decomposes the input query into a prompt tree 310 that comprises a plurality of simple sub-prompts. An application selection engine 312 processes the simple sub-prompts to determine if any of the simple sub-prompts 310 are addressable by one or more external application 314. For each sub-prompt determined to be addressable by an external application 314, the application selection engine 312 invokes the respective external application 314 using the simple sub-prompt. The external application 314 processes data from the simple sub-prompt to generate a response 324 and provides the response to the NL based response system 302. A prompt preparation engine 316 uses the responses to generate an LLM prompt 318 for one or more LLMs 320. The one or more LLMs 320 process the LLM prompt 318 to generate a response 322 to the input query 304. One or more of the responses 222 are output to a user via the user application 306 on the client device.

The input query 304 can correspond to the input query described in relation to input query 204 of FIG. 2. As an example, an input query 304 may be “What flights and hotels are available to Japan in the sakura season?”.

The decomposition model 308 corresponds, for example, to the decomposition model 210 of FIG. 2. Following the example above, the input query 304 “What flights and hotels are available to Japan in the sakura season?” may be decomposed into the sub-prompts/queries “When is sakura season in Japan”, “what is the hotel availability in sakura season” and “what is the flight availability in sakura season”.

The application selection engine 312 determines, for each of the sub-prompts, whether to invoke an external application 314. Each external application may be associated with a respective domain of expertise. The application selection engine 312 compares the sub-prompts 310 (or the contents of the sub-prompts) to the respective domains of expertise of the external applications 314 to determine if the subject matter of the sub-prompt falls within the domain of expertise of an external application, i.e., is addressable by an external application 314. In some examples, the application selection can also determine that one or more of the sub-prompts are addressable by an LLM 220 without invoking an external application 314.

For example, the application selection engine 312 may determine that the sub-prompt “When is sakura season in Japan” is addressable by a search engine application (e.g. application 1 314A), the sub-prompt “what is the hotel availability in sakura season” is addressable by a hotel booking application (e.g. application 1 314B), and the sub-prompt “what is the flight availability in sakura season” is addressable by a flight booking application (e.g. application 1 314C).

The application selection engine 312 invokes the respective external applications for the sub-prompts that fall within their respective domains of expertise. The application selection engine may extract pertinent information from the sub-prompts to use in respective application-program interfaces (APIs) of the external applications, e.g., extract dates, identities, addresses etc. from the sub-prompts to fill in elements of the APIs of the external applications.

The application selection engine can, in some examples, invoke the respective external applications sequentially, for example based on dependencies between the sub-prompts. For example, the application selection engine may invoke the search engine using the sub-prompt “When is sakura season in Japan” to determine the range of dates corresponding to the sakura season. The range of dates is then used when invoking the hotel booking application using the sub-prompt “what is the hotel availability in sakura season” and the flight booking application using the sub-prompt “what is the flight availability in sakura season”, e.g., the phrase “sakura season” may be replaced by the range of dates.

The external applications 314 return respective responses 324 to the NL processing system 312. Following the sakura example, the search engine may return the response “Late March to Early April”, the hotel booking engine may return a response indicating hotel availability in late March to early April and the flight booking engine may return a response indicating flight availability in late March to early April.

The prompt preparation engine uses the input query 304 and the responses 324 from the external application to generate a prompt 318 for the one or more LLMs 320. The LLM prompt 318 may comprise the input prompt and the plurality of sub-prompts 310, with their corresponding external application responses 324, if applicable. The one or more LLMs 320 process the LLM prompt 318 to generate one or more responses 322. One or more of the generated responses are output to via the client device 306.

Turning now to FIG. 4, FIG. 4 illustrates an example of a prompt decomposition tree 400. The prompt tree 400 comprises a first layer that includes a root node 402 corresponding to a full input prompt/query, which in the example shown is the same as described in relation to FIG. 2, i.e., “Does Company X have a larger number of engineers doing ML than Company Y?”.

The input prompt is broken down into a plurality of sub-prompts, in this example two sub-prompts, which a second layer of nodes 404 of the prompt tree. In this example, the sub-prompts are “How many engineers does company X have working on ML?” 404A and “How many engineers does company Y have working on ML?” 404B. Both prompts can be broken down into further sub-prompts, so the first layer of nodes 404 in this example comprises a plurality of branch nodes 404A, 404B. However, it will be appreciated that in general one or more of the sub-prompts in the first layer of nodes 404 may be leaf nodes that correspond to simple sub-prompts, e.g., sub-prompts that cannot be broken down further.

One or more of the sub-prompts that form the second layer of the prompt tree 400 may be further broken down into a third layer 406 of sub-prompts. Each node in the third layer 406 may be a branch node (i.e., correspond to a sub-prompt that can be broken down further into simpler sub-prompts) or a leaf node (e.g., correspond to a sub-prompt that cannot be broken down further, i.e., a simple sub-prompt, or a sub-prompt that is actionable by an external application). In the example shown, the third layer of sub-prompts has four leaf nodes 406A-D, corresponding to the simple sub-prompts “What percentage of company X engineers work on ML?” 406A, “How many engineers does company X have?” 406B, “What percentage of company Y engineers work on ML?” 406C, “How many engineers does company Y have?” 406D.

A prompt complexity for the input prompt may be determined based on the path length of the prompt tree 400. A total path length may be determined based on summing a plurality of path lengths, each of which corresponds to a path between a respective leaf node 406A-D and the root node 402. In the example shown there are four such paths, each of length three (or two in examples where the root node 402 is not counted): a first path to/from leaf node 406A from/to root node 402, via branch node 404A; a second path to/from leaf node 406B from/to root node 402, via branch node 404A; a third path to/from leaf node 406C from/to root node 402, via branch node 404B; and a fourth path to/from leaf node 406D from/to root node 402, via branch node 404B. The total path length in this example is therefore twelve (or eight, if the root node is not counted in the path length).

The prompt complexity is, in some examples, determined by taking a logarithm of the total path length. For example, a base two logarithm of the total path length may be taken, i.e., complexity=log₂(total_path_lenth). For the example shown, this gives a complexity of 3.585 (or 3, if the root node is not counted in the path length).

Turning now to FIG. 5 a flowchart is depicted that illustrates an example method 500 for determining whether to include an input prompt in a set of training/evaluation prompts. The method 500 corresponds to the method 200 described in relation to FIG. 2. For convenience, the operations of the method 500 are described with reference to a system that performs the operations. This system of the method 500 includes one or more processors, memory, and/or other component(s) of computing device(s) (e.g., the NL-based response system 120 of FIG. 1). Moreover, while operations of the method 400 are shown in a particular order, this is not meant to be limiting. One or more operations may be reordered, omitted, and/or added.

At block 552, the system receives an input prompt (also referred to herein as an “input query”) for an LLM. The prompt comprises an input text query. The query can be one formulated based on user interface input at a client device, such as typed input, voice input, input to cause an image to be captured or selected, etc. The text query can be, for example, a voice query, a typed query, or an inferred/parameterless query. In some implementations, when the query includes content that is not in textual format, the system can convert the query to a textual format or other format. For example, if the query is a voice query the system can perform automatic speech recognition (ASR) to convert the voice query into textual format.

The query can alternatively be an implied query, such as one formulated and/or submitted independent of any user input directed to formulating the implied query. For example, the query can be an implied query that is automatically generated based on profile data and that is automatically submitted. For instance, the implied query can be “machine learning”, based on profile data indicating interest in machine learning topic(s). As another example, the query can be an implied query that is automatically generated and/or automatically submitted based on a current and/or recent context. As yet another example, the query can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 554, the system decomposes the input prompt into a prompt tree. In some examples, the LLM is used to perform the decomposition. For example, the LLM is provided with a decomposition instruction and the full input prompt, e.g., a text instruction to decompose the input prompt into a plurality of simpler sub-prompts until the simpler sub-prompts cannot be decomposed further or until some other target simplicity is reached.

The prompt tree comprises a root node corresponding to the input prompt and a plurality of leaf nodes corresponding to the simple sub-prompts that the input prompt has been decomposed into. The prompt tree may further comprise a plurality of branch nodes between the root node and two or more of the leaf nodes that correspond to intermediate sub-prompts of the decomposition, e.g., sub-prompts that are simpler than the input prompt but that can still be decomposed further. An example of a prompt tree is described herein with respect to FIG. 3.

Decomposing the input prompt into the prompt tree may comprise decomposing the input prompt into a first set of sub-prompts using the LLM and iteratively decomposing, using the LLM, each sub-prompt into a further set of sub-prompts until the target simplicity is reached.

The system may, for example, determine that the target simplicity is reached for a given sub-prompt by determining that the given sub-prompt cannot be decomposed further by the LLM. Alternatively or additionally, system may determine that the target simplicity is reached by determining that the given sub-prompt falls within a domain of expertise of one or more expert models accessible by the LLM, i.e. that the sub-prompt can be used as input to the one or more expert models, or that data extracted from the sub-prompt can be used to invoke the expert model. Alternatively or additionally, system may determine that the target simplicity is reached by determining that the LLM classifies the sub-prompt as a simple sub-prompt, e.g., a prompt addressable directly by the LLM.

At block 556, the system determines a prompt complexity based on a path length of the prompt tree. The path length may be a total path length comprising a sum of respective path lengths from the root node to a respective leaf node. A complexity function may be applied to the path length to determine the complexity, e.g., a logarithm of the path length may be taken, such as log₂(total_path_lenth).

Blocks 554 and 558 are in some implementations, performed multiple times, e.g., 8 times. Since LLMs in general have a probabilistic output, multiple breakdowns (“decodes”) of the input prompt into simple sub-prompts may be possible, and each may have its own complexity. To account for this, the input prompt may be decomposed multiple times, with a respective complexity determined for each resulting prompt tree. An overall prompt complexity may be determined by averaging the prompt complexity over the plurality of generated prompt trees.

At block 558, the system compares the prompt complexity to a threshold complexity. In some implementations, the threshold complexity is a fixed value, with input prompts having a complexity above the threshold value being considered “hard” prompts. Alternatively, the threshold complexity is, in some implementations, a dynamic threshold that depends on the performance of the LLM, e.g., the threshold complexity is higher for higher performing LLMs and lower for lower performing LLMs, where performance is measured, for example, based on an LLMs responses to an evaluation dataset.

At block 560, in response to determining that the prompt complexity is above the threshold complexity, the system includes the input prompt in a set of training prompts and/or a set of evaluation prompts.

In some implementations, the system, or a further system, uses the set of training prompts to train the LMM or a further LLM.

Turning now to FIG. 6 a flowchart is depicted that illustrates an example method 500 of using one or more external applications to respond to a complex query. The method 600 corresponds to the method 300 described in relation to FIG. 3. For convenience, the operations of the method 600 are described with reference to a system that performs the operations. This system of the method 600 includes one or more processors, memory, and/or other component(s) of computing device(s) (e.g., the NL-based response system 120 of FIG. 1). Moreover, while operations of the method 500 are shown in a particular order, this is not meant to be limiting. One or more operations may be reordered, omitted, and/or added. One or more of the operations may be performed alongside or in addition to operations of FIG. 4, e.g. in parallel or in sequence.

At block 652, an input prompt/query for am LLM is received from a client device. The prompt comprises an input text query. Block 652 may, for example, correspond to block 552 of FIG. 5.

At block 654, the system decomposes the input prompt into a plurality of simpler sub-prompts using the LLM. The plurality of simple sub-prompts may each have at least a target simplicity. For example, the LLM may be provided with the input prompt and an instruction to decompose the input prompt into a plurality of simple sub-prompts. Following the holiday example, the LLM may be provided with the instruction “Decompose the following prompt into a set of simple sub-prompts: [prompt]”

Decomposing the input prompt into a plurality of simple sub-prompts comprises, in some implementations, decomposing the input prompt into a first set of sub-prompts using the LLM; and iteratively decomposing, using the LLM, each sub-prompt into a further set of sub-prompts until the target simplicity is reached.

In some implementations, the method further comprises determining that a given sub-prompt, of the sub-prompts, has the target simplicity. Determining that the given sub-prompt has the target simplicity comprises comprising one or more of: determining that no further decomposition of the given sub-prompt is achievable by the LLM, i.e., that the LLM cannot break the sub-prompt down into simpler sub-prompts; determining that the given sub-prompt falls within a domain of expertise of the external application accessible by the LLM, e.g., an external application can process the given sub-prompt, or data derived/extracted from the sub-prompt, to generate a response and/or perform an action; and/or determining that the LLM classifies the sub-prompt as a simple sub-prompt.

At block 656, for one or more sub-prompts in the plurality of simple sub-prompts, the system determines to invoke an external application from a plurality of external applications accessible by the LLM.

For a further prompt in the plurality of simple sub-prompts, the system may determine to invoke a further external application from the plurality of external application accessible by the LLM, based at least in part on the further sub-prompt relating to further subject matter within a further domain of said further external application.

At block 658, the system invokes the external application using the one or more simpler sub-prompts. In some examples, e.g., where the external application is equipped with a natural language processing capability, the external application may be invoked using the one or more simple sub-prompts directly, i.e., the system transmits the one or more simple sub-prompts to the external application. Alternatively or additionally, the system can extract data from the one or more simple sub-prompts for use in an API of the external application, e.g., extract user identities, dates, locations etc. from the one or more simple sub-prompts.

In examples where the system determines to invoke a further external application in the plurality of external applications, the system invokes the further external application using the one or more further simple sub-prompts.

At block 660, the system receives, responsive to invoking the external application using the one or more simple sub-prompts, one or more responses from the external application. In examples where the external application has NL processing capability, the response can be in the form of a natural language response. Alternatively, the response can be data in the API format of the external application.

In examples where the system also invoked a further application, the system further receives, responsive to invoking the further external application using the further sub-prompt, a further response from the further external application.

In some implementations, the system generates an additional response based on processing an additional sub-prompt using the LLM and without invoking any external application using the additional sub-prompt, i.e., the LLM generates a response to the additional sub-prompt itself without any external input.

At block 662, the system generates, using the LLM, a response to the input prompt based at least in part on the one or more responses from the external application. The LLM processes the response from the further application and, in some examples, the original input prompt to generate a natural language (e.g., text) response, and outputs the response.

In examples where the system received a further response from the further external application, the response to the input prompt may also be based at least in part on the further response. In examples where the LLM generated an additional response itself, the response to the input prompt may be based at least in part on the additional response.

At block 664, the system causes the response to be rendered at the client device. For example, the system can cause the response to be rendered graphically in an interface of an application of a client device via which the query was submitted. As another example, the system can additionally or alternatively cause the response to be audibly rendered via speaker(s) of a client device via which the query was submitted. The response can be transmitted from the system to the client device, if the system is remote from the client device.

Turning now to FIG. 7, a block diagram of an example computing device 710 that may optionally be utilized to perform one or more aspects of techniques described herein is depicted. In some implementations, one or more of a client device, cloud-based automated assistant component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 625 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some, or all, of the modules described herein. For example, the storage subsystem 724 may include the logic to perform selected aspects of the methods disclosed herein, as well as to implement various components depicted in FIG. 1.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations a method implemented by processor(s) is provided and includes receiving an input prompt for a large language model, LLM, and decomposing the input prompt into a prompt tree. The prompt tree includes a plurality of nodes of sub-prompts that form the input prompt. The plurality of nodes include a plurality of leaf nodes corresponding to simple sub-prompts of the input query, a plurality of branch nodes of sub-prompts each corresponding to multiple simple sub-prompts, and a root node corresponding to the input prompt. The method further includes determining a prompt complexity based on a path length of the prompt tree. The method further includes comparing the prompt complexity to a threshold complexity, and, in response to determining, based on the comparing, that the prompt complexity is above the threshold complexity: including the input prompt in a set of training prompts and/or a set of evaluation prompts.

These and other implementations disclosed herein can include one or more of the following features.

In some implementations, the simple sub-prompts that correspond to the leaf nodes of the prompt tree have at least a target simplicity. In some versions of those implementations, decomposing the input prompt into the prompt tree includes decomposing the input prompt into a first set of sub-prompts using the LLM and iteratively decomposing, using the LLM, each sub-prompt into a further set of sub-prompts until the target simplicity is reached. In some additional or alternative versions of those implementations, the method further includes determining that a given sub-prompt, of the sub-prompts, has the target simplicity, the determining including one or more of: determining that no further decomposition of the given sub-prompt is achievable by the LLM; determining that the given sub-prompt falls within a domain of expertise of one or more expert models accessible by the LLM; and/or determining that the LLM classifies the sub-prompt as a simple sub-prompt.

In some implementations, determining the prompt complexity based on a path length of the prompt tree includes determining the path length of the prompt tree, including summing a plurality of leaf path lengths, each leaf path length corresponding to a path from the root node to a respective leaf node. In some of those implementations, determining the prompt complexity based on the path length of the prompt tree includes determining a logarithm of the path length.

In some implementations, determining the prompt complexity based on the path length of the prompt tree includes averaging the complexity over a plurality of decodings of the input prompt.

In some implementations, the input prompt is included in the set of training prompts in response to determining that the prompt complexity is above the threshold complexity, and the method further includes training parameters of the LLM, and/or of an additional LLM, based on the set of training prompts.

In some implementations, the input prompt is included in the set of evaluation prompts in response to determining that the prompt complexity is above the threshold complexity, and the method further includes evaluating a performance of the LLM based on the set of evaluation prompts.

In some implementations, the threshold complexity is a dynamic threshold complexity that is based on a performance of the LLM.

In some implementations, a method implemented by processor(s) is provided and includes receiving, from a client device, an input prompt for a large language model, LLM, and decomposing, using the LLM, the input prompt into a plurality of simple sub-prompts. The method further includes, for one or more sub-prompts in the plurality of simple sub-prompts, determining to invoke an external application from a plurality of external application accessible by the LLM, based at least in part on: the one or more simple sub-prompt relating to subject matter within a domain of said external application. The method further includes invoking the external application using the one or more simple sub-prompts and receiving, responsive to invoking the external application using the one or more simple sub-prompts, one or more responses from the external application. The method further includes generating, by the LLM, a response to the input prompt based at least in part on the one or more responses from the external application and causing the response to be rendered at the client device.

These and other implementations disclosed herein can include one or more of the following features.

In some implementations, the simple sub-prompts each have at least a target simplicity. In some versions of those implementations, decomposing the input prompt into the plurality of simple sub-prompts includes decomposing the input prompt into a first set of sub-prompts using the LLM and iteratively decomposing, using the LLM, each sub-prompt into a further set of sub-prompts until the target simplicity is reached. In some additional or alternative versions of those implementations, the method further includes determining that a given sub-prompt, of the sub-prompts, has the target simplicity, the determining including one or more of: determining that no further decomposition of the given sub-prompt is achievable by the LLM; determining that the given sub-prompt falls within a domain of expertise of the external application accessible by the LLM; and/or determining that the LLM classifies the sub-prompt as a simple sub-prompt.

In some implementations, the method further includes, for an additional sub-prompt in the plurality of simple sub-prompts, generating an additional response based on processing the additional sub-prompt using the LLM and without invoking any external application using the additional sub-prompt, where generating, by the LLM, the response to the input prompt is further based at least in part on the additional response.

In some implementations, the method further includes: for a further sub-prompt in the plurality of simple sub-prompts, determining to invoke a further external application from the plurality of external application accessible by the LLM, based at least in part on: the further sub-prompt relating to further subject matter within a further domain of said further external application; and receiving, responsive to invoking the further external application using the further sub-prompt, a further response from the further external application, where generating, by the LLM, the response to the input prompt is further based at least in part on the further response.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving an input prompt for a large language model, LLM;
decomposing the input prompt into a prompt tree, the prompt tree comprising a plurality of nodes of sub-prompts that form the input prompt, the plurality of nodes comprising:
a plurality of leaf nodes corresponding to simple sub-prompts of the input query,
a plurality of branch nodes of sub-prompts each corresponding to multiple simple sub-prompts, and
a root node corresponding to the input prompt;
determining a prompt complexity based on a path length of the prompt tree;
comparing the prompt complexity to a threshold complexity; and
in response to determining, based on the comparing, that the prompt complexity is above the threshold complexity:
including the input prompt in a set of training prompts and/or a set of evaluation prompts.

2. The method of claim 1, wherein the simple sub-prompts that correspond to the leaf nodes of the prompt tree have at least a target simplicity.

3. The method of claim 2, wherein decomposing the input prompt into the prompt tree comprises:
decomposing the input prompt into a first set of sub-prompts using the LLM; and
iteratively decomposing, using the LLM, each sub-prompt into a further set of sub-prompts until the target simplicity is reached.

4. The method of claim 2, further comprising determining that a given sub-prompt, of the sub-prompts, has the target simplicity, determining that the given sub-prompt has the target simplicity comprising one or more of:
determining that no further decomposition of the given sub-prompt is achievable by the LLM;
determining that the given sub-prompt falls within a domain of expertise of one or more expert models accessible by the LLM; and/or
determining that the LLM classifies the sub-prompt as a simple sub-prompt.

5. The method of claim 1, wherein determining the prompt complexity based on a path length of the prompt tree comprises:
determining the path length of the prompt tree, comprising summing a plurality of leaf path lengths, each leaf path length corresponding to a path from the root node to a respective leaf node.

6. The method of claim 5, wherein determining the prompt complexity based on the path length of the prompt tree comprises:
determining a logarithm of the path length.

7. The method of claim 1, wherein determining the prompt complexity based on the path length of the prompt tree comprises:
averaging the complexity over a plurality of decodings of the input prompt.

8. The method of claim 1, wherein the input prompt is included in the set of training prompts in response to determining that the prompt complexity is above the threshold complexity, and the method further comprises:
training parameters of the LLM, and/or of an additional LLM, based on the set of training prompts.

9. The method of claim 1, wherein the input prompt is included in the set of evaluation prompts in response to determining that the prompt complexity is above the threshold complexity, and the method further comprises:
evaluating a performance of the LLM based on the set of evaluation prompts.

10. The method of claim 1, wherein the threshold complexity is a dynamic threshold complexity that is based on a performance of the LLM.

11. A system comprising:
one or more processors; and
memory, the memory storing computer readable instructions that, when executed by the one or more processors, cause the system to:
receive an input prompt for a large language model, LLM;
decompose the input prompt into a prompt tree, the prompt tree comprising a plurality of nodes of sub-prompts that form the input prompt, the plurality of nodes comprising:
a plurality of leaf nodes corresponding to simple sub-prompts of the input query,
a plurality of branch nodes of sub-prompts each corresponding to multiple simple sub-prompts, and
a root node corresponding to the input prompt;
determine a prompt complexity based on a path length of the prompt tree;
compare the prompt complexity to a threshold complexity; and
in response to determining, based on the comparing, that the prompt complexity is above the threshold complexity:
include the input prompt in a set of training prompts and/or a set of evaluation prompts.

12. The system of claim 11, wherein the simple sub-prompts that correspond to the leaf nodes of the prompt tree have at least a target simplicity.

13. The system of claim 12, wherein in decomposing the input prompt into the prompt tree the system is to:
decompose the input prompt into a first set of sub-prompts using the LLM; and
iteratively decompose, using the LLM, each sub-prompt into a further set of sub-prompts until the target simplicity is reached.

14. The system of claim 13, wherein the instructions, when executed by the one or more processors, further cause the system to determine that a given sub-prompt, of the sub-prompts, has the target simplicity, wherein in determining that the given sub-prompt has the target simplicity the system is to:
determine that no further decomposition of the given sub-prompt is achievable by the LLM;
determine that the given sub-prompt falls within a domain of expertise of one or more expert models accessible by the LLM; and/or
determine that the LLM classifies the sub-prompt as a simple sub-prompt.

15. A method implemented by one or more processors, the method comprising:
receiving, from a client device, an input prompt for a large language model, LLM;
decomposing, using the LLM, the input prompt into a plurality of simple sub-prompts;
for one or more sub-prompts in the plurality of simple sub-prompts, determining to invoke an external application from a plurality of external application accessible by the LLM, based at least in part on:
the one or more simple sub-prompt relating to subject matter within a domain of said external application;
invoking the external application using the one or more simple sub-prompts;
receiving, responsive to invoking the external application using the one or more simple sub-prompts, one or more responses from the external application;
generating, by the LLM, a response to the input prompt based at least in part on the one or more responses from the external application; and
causing the response to be rendered at the client device.

16. The method of claim 15, wherein the simple sub-prompts each have at least a target simplicity.

17. The method of claim 16, wherein decomposing the input prompt into the plurality of simple sub-prompts comprises:
decomposing the input prompt into a first set of sub-prompts using the LLM; and
iteratively decomposing, using the LLM, each sub-prompt into a further set of sub-prompts until the target simplicity is reached.

18. The method of claim 16, further comprising determining that a given sub-prompt, of the sub-prompts, has the target simplicity, determining that the given sub-prompt has the target simplicity comprises comprising one or more of:
determining that no further decomposition of the given sub-prompt is achievable by the LLM;
determining that the given sub-prompt falls within a domain of expertise of the external application accessible by the LLM; and/or
determining that the LLM classifies the sub-prompt as a simple sub-prompt.

19. The method of claim 15, further comprising:
for an additional sub-prompt in the plurality of simple sub-prompts, generating an additional response based on processing the additional sub-prompt using the LLM and without invoking any external application using the additional sub-prompt;
wherein generating, by the LLM, the response to the input prompt is further based at least in part on the additional response.

20. The method of claim 15, further comprising:
for a further sub-prompt in the plurality of simple sub-prompts:
determining to invoke a further external application from the plurality of external application accessible by the LLM, based at least in part on:
the further sub-prompt relating to further subject matter within a further domain of said further external application; and
receiving, responsive to invoking the further external application using the further sub-prompt, a further response from the further external application;
wherein generating, by the LLM, the response to the input prompt is further based at least in part on the further response.
